(19) United States
(12) Patent Application Publication
(10) Pub. No.: US 2019/0066479 A1
(43) Pub. Date: Feb. 28, 2019

(54) METHOD AND SYSTEM FOR MONITORING AND PREDICTING GAS LEAK

(71) Applicant: HALLIBURTON ENERGY SERVICES, INC., Houston, TX (US)

(72) Inventors: Avinash WESLEY, Houston, TX (US); Jianxin LU, Bellaire, TX (US); Ilyas UYANIK, Houston, TX (US)

(73) Assignee: HALLIBURTON ENERGY SERVICES, INC., Houston, TX (US)

(21) Appl. No.: 15/763,261

(22) PCT Filed: Nov. 19, 2015
(86) PCT No.: PCT/US15/61634

§ 371 Date: Mar. 26, 2018

(51) Int. Cl. G08B 21/16; G06F 17/50; G06N 5/04; G06Q 10/06; G06Q 50/06

(52) U.S. Cl. CPC G08B 21/16; G06F 17/5009; G06Q 50/06; G06Q 10/0635; G06N 5/04

(57) ABSTRACT

A system and method for monitoring and predicting a gas leak at a facility involving receiving, via a server, real-time data measured via a plurality of sensors spaced throughout a facility; scrubbing, via the server, the real-time data by removing a plurality of spikes, a plurality white noise, or a combination thereof, from the real-time data to yield a set of scrubbed data; determining a gas leak location within the facility based on the scrubbed data; conducting a gas leak simulation based on the scrubbed data; determining a potential gas leak distribution based on the scrubbed data and the gas leak simulation; calculating a risk profile based on a set of predetermined risk parameters; generating a notification based on the potential gas leak distribution and the risk profile; and transmitting over a network, the risk profile and the potential gas leak distribution to at least one mobile device.

### FIELD

The present disclosure generally relates to methods and systems for gas leak detection in upstream facilities. In particular, the subject matter herein relates to real-time monitoring and prediction of gas leak flow patterns.

### BACKGROUND

During upstream drilling/production operations or downstream refining processes, poisonous, highly flammable hazardous gases can be released into the environment. The expelled gasses can pose serious health risks to those working in and around the facility. Facilities typically use gas detectors in order to alert workers that a leak is present within the facility, and such detectors can sound an alarm when a certain gas is detected.

### BRIEF DESCRIPTION OF THE DRAWINGS

Implementations of the present technology will now be described, by way of example only, with reference to the attached figures, wherein:

FIG. 1 is a diagram illustrating an exemplary gas leak detection system according to the disclosure herein;

FIG. 2 is a diagram illustrating a second exemplary gas leak detection system, according to the disclosure herein;

FIG. 3A illustrates an exemplary system embodiment according to the disclosure herein;

FIG. 3B illustrates a second exemplary system embodiment according to the disclosure herein;

FIG. 4 is a flowchart illustrating a method for alerting workers of a gas leak according to the disclosure herein;

FIG. 5A is a diagrammatic view of a cellular phone application;

FIG. 5B is a second diagrammatic view of a cellular phone application; and

FIG. 6 is a diagram of an example system for delivering notifications according to the disclosure herein.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented. The term “coupled” is defined as connected, whether directly or indirectly through intervening components, and is not necessarily limited to physical connections. The connection can be such that the objects are permanently connected or releasably connected. The terms “comprising,” “including,” and “having” are used interchangeably in this disclosure. The terms “comprising,” “including,” and “having” mean to include, but not necessarily be limited to, the things so described.

Disclosed herein are a method and a system for detecting a gas leak, determining the most likely distribution of the leak, and notifying nearby workers of the risk. Real-time data obtained from a plurality of sensors throughout a facility can be sent to a server for data aggregation and cleaning. A predicted gas distribution is obtained through the mathematical simulation of the real-time gas leak data in combination with wind velocity and facility geometry. Predetermined risk profiles can be used to evaluate the danger of the gas leak and an alert can be created, based on the risk profiles and predicted gas flow, and sent to nearby workers. The system and method described below can be implemented on both land and sea based drilling sites.

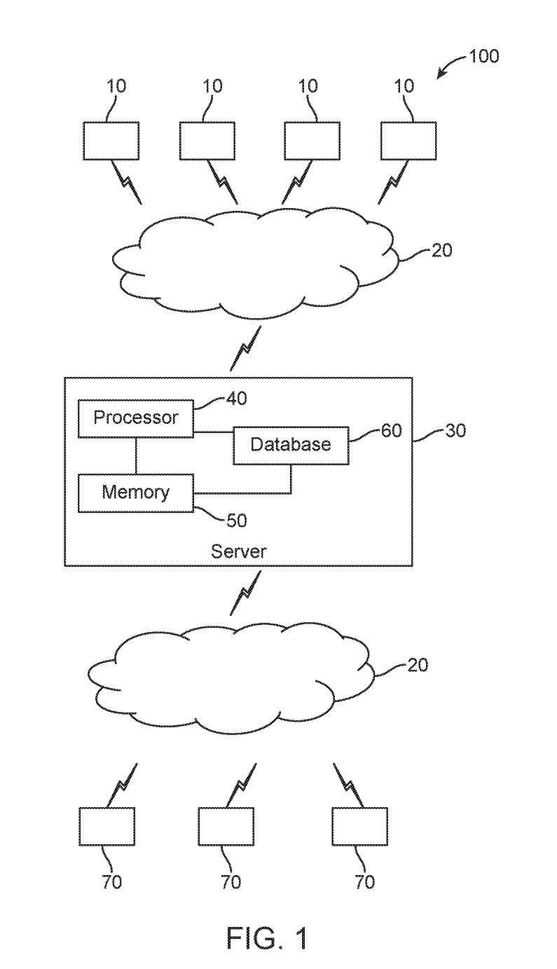

FIG. 1 illustrates a system 100 for detecting and notifying workers of a gas leak within a facility. A plurality of sensors 10 can be placed throughout a facility such that a gas leak in any part of the facility can be quickly detected. The sensors 10 can be configured to measure characteristics of the environment, including the presence and concentration of various gases, such as carbon dioxide (CO₂) sensors, hydrogen sulfide (H₂S) sensors, and weather sensors. Sensors measuring CO₂ and H₂S can be commercially obtained from Detcon, Inc., for example the Model 1000-H2S—CO2 hydrogen sulfide/carbon dioxide analyzer. Although CO₂ and H₂S are specifically discussed above, it should be understood by those of skill in the art that the present disclosure is equally well-suited for detecting other gases. Weather sensors configured to measure wind speed and direction can be obtained from Acurite, for example the 5-in-1 Weather Sensor. The sensors 10 can be placed throughout the facility at the height at which an average person would be breathing, for example, 4 to 6 feet above ground level. In the alternative, the sensors 10 can be placed at a height at which workers may be sitting or standing during wellbore operations.

The environmental characteristic data can then be transmitted over a network 20 to a server 30. The server 30 can include a processor 40 communicatively coupled with a memory 50, configured to store instructions, and a database 60, including data, such as facility geometry. When a gas leak is detected within the facility a notification can be sent from the server 30 over a network 20 to each of a plurality of mobile devices 70, apprising workers of the leak. The notification can be generalized, showing the gas distribution across the entire facility. In the alternative, the plurality of mobile devices 70 can be equipped with a global positioning system (GPS) such that the notification can be customized based on the proximity of the mobile device 70 to the leak. Although the use of a mobile device is described above, it should be understood by those of skill in the art that the present disclosure is equally well-suited for use on laptops, smart phones, small form factor personal computers, personal digital assistants, rackmount devices, standalone devices, and similar devices capable of accessing a web application.

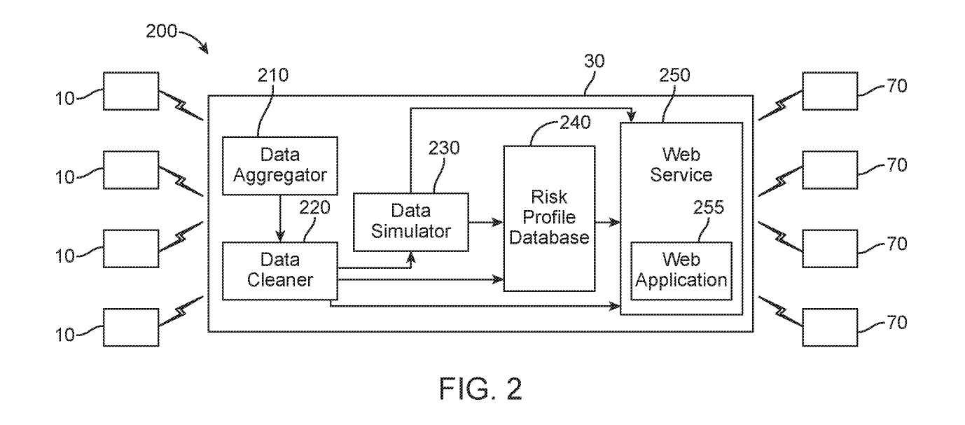

The detection and notification process is further detailed in FIG. 2. The system 200 can include a plurality of sensors 10, a server 30 and a plurality of mobile devices 70, as described above with respect to FIG. 1. The server 30 can further include a data aggregator 210, configured to receive the data transmitted from each of the plurality of sensors 10 and communicatively coupled with a data cleaner 220. The data cleaner 220 can be configured to remove noise from the data including, but not limited to, sensor noise, spikes, and white noise. The data cleaner 220 can be communicatively coupled with a data simulator 230 configured to run a Computational Fluid Dynamics (CFD) simulation on the data in order to provide multiphase, multiphysics flow behavior. The simulation can be achieved through the use of a steady state solution of a Realizable k-E model for turbulent gas flow and species diffusion using convective diffusion equation.

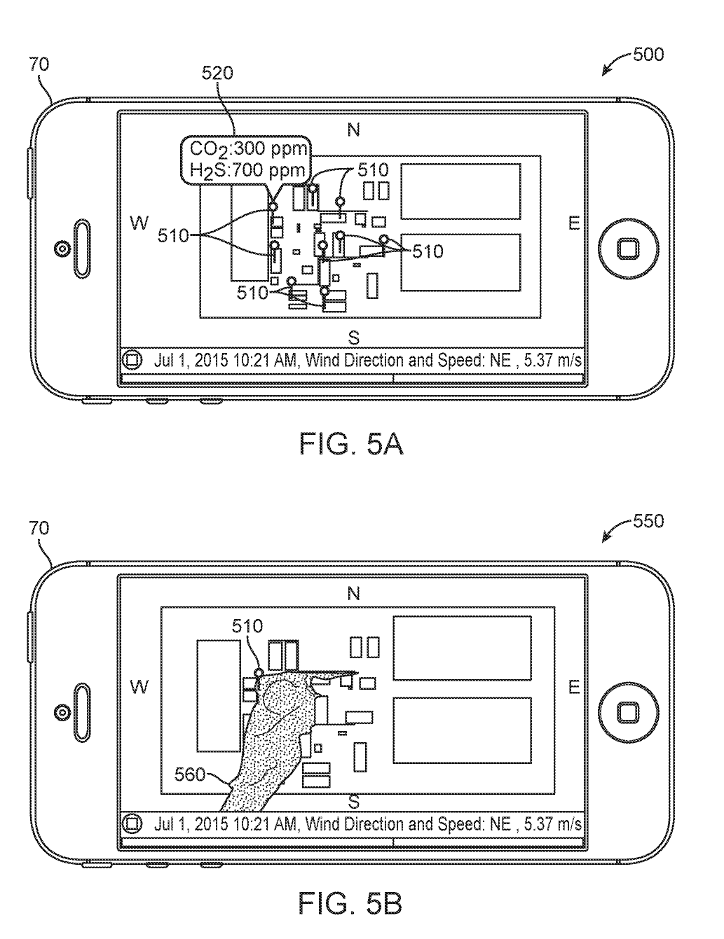

The CFD simulation can be created using information including, but not limited to, facility geometry (obtained from database 60, shown in FIG. 1), leak location, leak rates, gas components, gas concentration, and wind speed and direction. The completed simulation output can be time stamped (as shown in FIGS. 5A and 5B) and the above processes can be repeated indefinitely in order to create a continuous stream of current gas leak information. The data simulator 230 can be communicatively coupled to a risk profile database 240 containing statistical risk data corresponding to the measured gas leak. The risk profile database 240 can obtain the environmental characteristic data from the data simulator 230 and directly from the data cleaner 220. The risk data can be obtained from government agencies, for example, the Environmental Protection Agency (EPA), the Occupational Safety and Health Administration (OSHA), and other similar agencies. Examples of such risk data is shown in Tables 1 and 2, below. Risk profiles, such as low risk, medium risk, and high risk, can be created based on the risk data and alarms or notifications can be configured for each risk profile.

TABLE 1

| CO₂ Concentration | | |
|---|---|---|
| (%) | Time | Effects |
| 17-30 | 1 minutes | Loss of controlled and purposeful |
| | | activity, unconsciousness, |
| | | convulsions, coma, death |
| >10-15 | 1 to several | Dizziness, drowsiness, severe |
| | minutes | muscle twitching, unconsciousness |
| 7-10 | Few minutes | Unconsciousness/near |
| | 1.5 minutes | unconsciousness |
| | to 1 hour | Headache, increased heart rate, |
| | | shortness of breath, dizziness, |
| | | sweating, rapid breathing |
| 6 | 1-2 minutes | Hearing and visual disturbances |
| | 16 minutes | Headache, dyspnea |
| | Several hours | Tremors |
| 4-5 | Within a few | Headache, dizziness, increased |
| | minutes | blood pressure, uncomfortable |
| | | dyspnea |
| 3 | 1 hour | Mild headache, sweating, and |
| | | dyspnea at rest |
| 2 | Several hours | Headache, dyspnea upon mild |
| | | exertion |

TABLE 2

| H₂S Concentration | |
|---|---|
| (ppm) | Effects |
| 0.1-3 | Odor threshold |
| 3-10 | Offensive odor |
| 10-50 | Headache, nausea, throat and eye irritation |
| 50-100 | Eye injury |
| 100-300 | Conjunctivitis, respiratory tract irritation, olfactory |
| | paralysis |
| 300-500 | Pulmonary edema, imminent threat to life |
| 500-1000 | Strong nervous system stimulation, apnea |
| 1000-2000 | Immediate collapse with respiratory paralysis, risk |
| | of death |

A web service 250 can be communicatively coupled with, and configured to receive data from, the data cleaner 220, the data simulator 230, and the risk profile database 240. The web service 250 can combine the simulation, the environmental characteristic data, and the alarms, such that the gas leak can be displayed on a web application 255 within the web service 250. The web application 255 can display the predicted gas flow distribution obtained from the simulation on a rendering of the facility as well as the risk profiles associated with the different exposure levels throughout the facility. The simulation rendering can be in the form of a still photograph showing where the gas leak is currently or where the gas leak will expand to in the near future. In the alternative, the simulation can be in the form of a video, showing the viewer the leak point and the expected gas distribution throughout the facility. The web application 255 can be accessed on a mobile device 70 connected to a network 20, such that workers throughout the facility can make informed decisions in case of emergency.

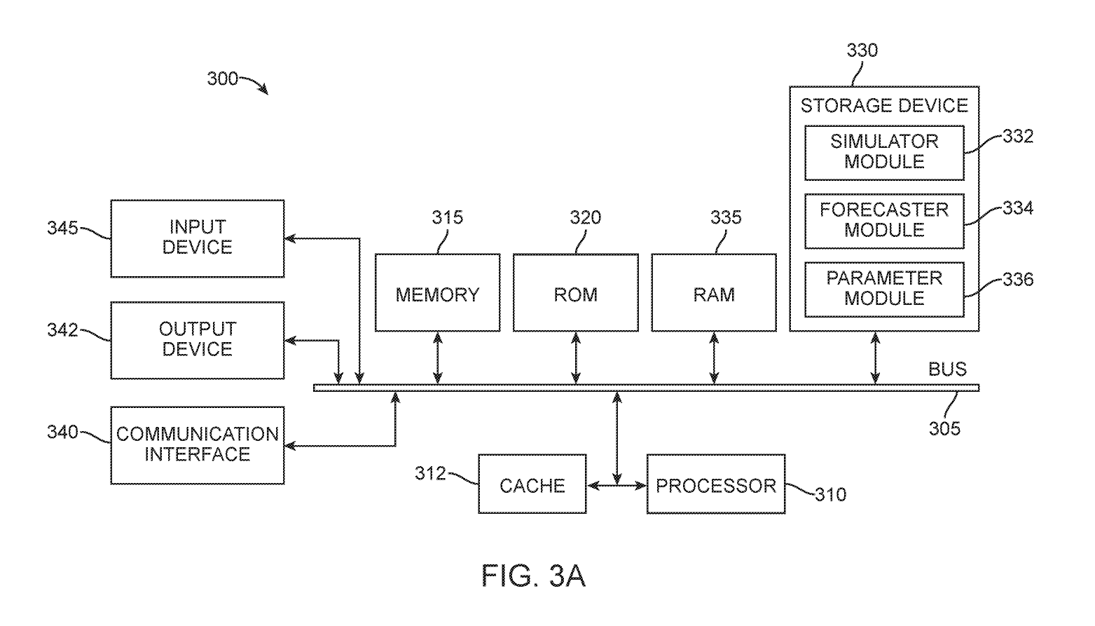

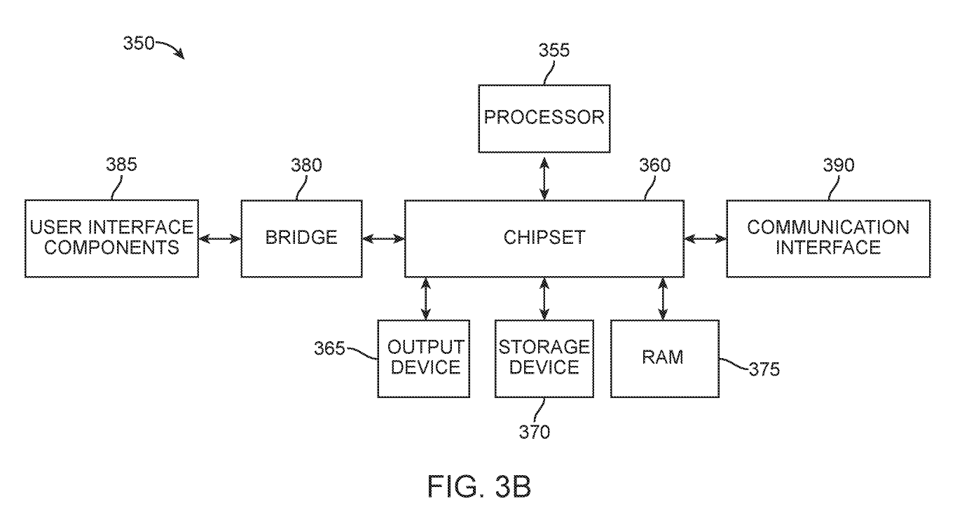

FIGS. 3A and 3B illustrate exemplary system embodiments which can be employed to practice the concepts, methods, and techniques disclosed herein. The more appropriate embodiment will be apparent to those of ordinary skill in the art when practicing the present technology. Persons of ordinary skill in the art will also readily appreciate that other system embodiments are possible.

FIG. 3A illustrates a conventional system bus computing system architecture 300 wherein the components of the system are in electrical communication with each other using a bus 305. System 300 can include a processing unit (CPU or processor) 310 and a system bus 305 that couples various system components including the system memory 315, such as read only memory (ROM) 320 and random access memory (RAM) 335, to the processor 310. For example, the processor of FIG. 1 can be a form of this processor 310. The system 300 can include a cache of high-speed memory connected directly with, in close proximity to, or integrated as part of the processor 310. The system 300 can copy data from the memory 315 and/or the storage device 330 to the cache 312 for quick access by the processor 310. In this way, the cache 312 can provide a performance boost that avoids processor 310 delays while waiting for data. These and other modules can control or be configured to control the processor 310 to perform various actions. Other system memory 315 may be available for use as well. The memory 315 can include multiple different types of memory with different performance characteristics. It can be appreciated that the disclosure may operate on a computing device 300 with more than one processor 310 or on a group or cluster of computing devices networked together to provide greater processing capability. The processor 310 can include any general purpose processor and a hardware module or software module, such as simulator module 332, forecaster module 334, and parameter module 336 stored in storage device 330, configured to control the processor 310 as well as a special-purpose processor where software instructions are incorporated into the actual processor design. The processor 310 may essentially be a completely self-contained computing system, containing multiple cores or processors, a bus, memory controller, cache, etc. A multi-core processor may be symmetric or asymmetric.

The system bus 305 may be any of several types of bus structures including a memory bus or a memory controller, a peripheral bus, and a local bus using any of a variety of bus architectures. A basic input/output (BIOS) stored in ROM 320 or the like, may provide the basic routine that helps to transfer information between elements within the computing device 300, such as during start-up. The computing device 300 further includes storage devices 330 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 330 can include software modules 332, 334, 336 for controlling the processor 310. The system 300 can include other hardware or software modules. The storage device 330 is connected to the system bus 305 by a drive interface. The drives and the associated computer-readable storage devices provide non-volatile storage of computer-readable instructions, data structures, program modules and other data for the computing device 300. In one aspect, a hardware module that performs a particular function includes the software components shorted in a tangible computer-readable storage device in connection with the necessary hardware components, such as the processor 310, bus 305, and so forth, to carry out a particular function. In the alternative, the system can use a processor and computer-readable storage device to store instructions which, when executed by the processor, cause the processor to perform operations, a method or other specific actions. The basic components and appropriate variations can be modified depending on the type of device, such as whether the device 300 is a small, handheld computing device, a desktop computer, or a computer server. When the processor 310 executes instructions to perform “operations”, the processor 310 can perform the operations directly and/or facilitate, direct, or cooperate with another device or component to perform the operations.

To enable user interaction with the computing device 300, an input device 345 can represent any number of input mechanisms, such as a microphone for speech, a touch-sensitive screen for gesture or graphical input, keyboard, mouse, motion input, speech and so forth. An output device 342 can also be one or more of a number of output mechanisms known to those of skill in the art. In some instances, multimodal systems can enable a user to provide multiple types of input to communicate with the computing device 300. The communications interface 340 can generally govern and manage the user input and system output. There is no restriction on operating on any particular hardware arrangement and therefore the basic features here may easily be substituted for improved hardware or firmware arrangements as they are developed.

Storage device 330 is a non-volatile memory and can be a hard disk or other types of computer readable media which can store data that are accessible by a computer, such as magnetic cassettes, flash memory cards, solid state memory devices, digital versatile disks (DVDs), cartridges, RAMs 325, ROM 320, a cable containing a bit stream, and hybrids thereof.

The logical operations of the various embodiments are implemented as: (1) a sequence of computer implemented steps, operations, or procedures running on a programmable circuit with a general use computer, (2) a sequence of computer implemented steps, operations, or procedures running on a specific-use programmable circuit; and/or (3) interconnected machine modules or program engines within the programmable circuits. The system 300 shown in FIG. 3A can practice all or part of the recited methods, can be a part of the recited systems, and/or can operate according to instructions in the recited tangible computer-readable storage devices.

One or more parts of the example computing device 300, up to and including the entire computing device 300, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 310 can include all types of processors disclosed herein, including a virtual processor. However, when referring to a virtual processor, the processor 310 includes the software components associated with executing the virtual processor in a virtualization layer and underlying hardware necessary to execute the virtualization layer. The system 300 can include a physical or virtual processor 310 that receives instructions stored in a computer-readable storage device, which causes the processor 310 to perform certain operations. When referring to a virtual processor 310, the system also includes the underlying physical hardware executing the virtual processor 310.

FIG. 3B illustrates an example computer system 350 having a chipset architecture that can be used in executing the described method and generating and displaying a graphical user interface (GUI). Computer system 350 can be computer hardware, software, and firmware that can be used to implement the disclosed technology. System 350 can include a processor 355, representative of any number of physically and/or logically distinct resources capable of executing software, firmware, and hardware configured to perform identified computations. Processor 355 can communicate with a chipset 360 that can control input to and output from processor 355. Chipset 360 can output information to output device 365, such as a display, and can read and write information to storage device 370, which can include magnetic media, and solid state media. Chipset 360 can also read data from and write data to RAM 375. A bridge 380 for interfacing with a variety of user interface components 385 can include a keyboard, a microphone, touch detection and processing circuitry, a pointing device, such as a mouse, and so on. In general, inputs to system 350 can come from any of a variety of sources, machine generated and/or human generated.

Chipset 360 can also interface with one or more communication interfaces 390 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 355 analyzing data stored in storage 370 or RAM 375. Further, the machine can receive inputs from a user via user interface components 385 and execute appropriate functions, such as browsing functions by interpreting these inputs using processor 355.

It can be appreciated that systems 300 and 350 can have more than one processor 310, 355 or be part of a group or cluster of computing devices networked together to provide processing capability. For example, the processor 310, 355 can include multiple processors, such as a system having multiple, physically separate processors in different sockets, or a system having multiple processor cores on a single physical chip. Similarly, the processor 310 can include multiple distributed processors located in multiple separate computing devices, but working together such as via a communications network. Multiple processors or processor cores can share resources such as memory 315 or the cache 312, or can operate using independent resources. The processor 310 can include one or more of a state machine, an application specific integrated circuit (ASIC), or a programmable gate array (PGA) including a field PGA.

Methods according to the aforementioned description can be implemented using computer-executable instructions that are stored or otherwise available from computer readable media. Such instructions can comprise instructions and data which cause or otherwise configured a general purpose computer, special purpose computer, or special purpose processing device to perform a certain function or group of functions. portions of computer resources used can be accessible over a network. The computer executable instructions may be binaries, intermediate format instructions such as assembly language, firmware, or source code. Computer-readable media that may be used to store instructions, information used, and/or information created during methods according to the aforementioned description include magnetic or optical disks, flash memory, USB devices provided with non-volatile memory, networked storage devices, and so on.

For clarity of explanation, in some instances the present technology may be presented as including individual functional blocks including functional blocks comprising devices, device components, steps or routines in a method embodied in software, or combinations of hardware and software. The functions these blocks represent may be provided through the use of either shared or dedicated hardware, including, but not limited to, hardware capable of executing software and hardware, such as a processor 310, that is purpose-built to operate as an equivalent to software executing on a general purpose processor. For example, the functions of one or more processors represented in FIG. 3A may be provided by a single shared processor or multiple processors. (use of the term “processor” should not be construed to refer exclusively to hardware capable of executing software.) Illustrative embodiments may include microprocessor and/or digital signal processor (DSP) hardware, ROM 320 for storing software performing the operations described below, and RAM 335 for storing results. Very large scale integration (VLSI) hardware embodiments, as well as custom VLSI circuitry in combination with a general purpose DSP circuit, may also be provided.

The computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing methods according to these disclosures can comprise hardware, firmware and/or software, and can take any of a variety of form factors. Such form factors can include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device.

The instructions, media for conveying such instructions, computing resources for executing them, and other structures for supporting such computing resources are means for providing the functions described in these disclosures.

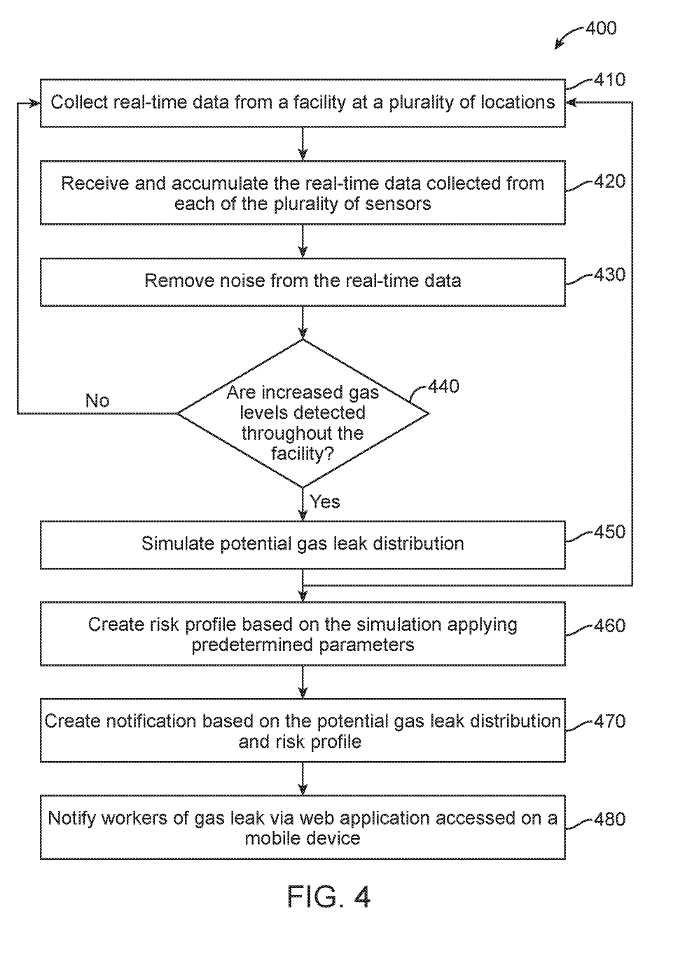

The method for creating and sending a notification of a hazardous gas leak within a facility can follow the flow diagram 400 depicted in FIG. 4. For example, beginning at block 410, real-time data can be collected at a plurality of locations where sensors have been place throughout the facility. In block 420, the real-time data is transmitted from each of the plurality of sensors via a network and received at a data aggregator communicatively coupled with a server. The real-time data is accumulated on the data aggregator and transmitted to a data cleaner. In block 430, the data cleaner removes noise from the real-time data, including spikes, white noise, and sensors noise. As shown in block 440, it is determined whether an increased gas level has been detected at any point throughout the facility. If no increased gas level is detected, the process does not proceed. However, data is continuously collected at all times such that a gas leak can be detected as soon as it occurs.

In the alternative, if increased gas levels are detected at a point within the facility the data is transferred to the data simulator, as shown in block 450. A simulation to determine the potential gas leak distribution is conducted and the information is transmitted to a risk profile database. The above described process can repeat on a continuous loop, such that the simulation is constantly updated with the real-time data acquired from each of the plurality of sensors producing an accurate simulation of the movement of the gas plume.

In block 460, a risk profile is created by applying predetermined parameters to the simulation showing the potential gas leak distribution. The risk profile is then transferred to a web service communicatively coupled with the risk profile database.

At block 470 a notification is configured describing the potential gas leak distribution and the risk level in different areas throughout the facility. In block 480, a web application is used to display the simulation on a rendering of the facility. The web application can be accessed by workers via a mobile device connected to a network such that they can receive the notification that a gas leak has been detected and can view the potential path of the gas leak.

An exemplary diagram 500 of the web application as displayed on a mobile device 70 is shown in FIG. 5A. A plurality of sensors 510 are shown spaced throughout a rendering of the facility. The rendering shows the floor plan of the facility as well as the location of doors and other objects that can affect the dispersal of a gas. Real-time wind speed and direction and an alert 520 notifying a viewer that an increased gas concentration has been detected at one of the sensors are also shown. FIG. 5B shows a second exemplary diagram 550 of the web application on a mobile device 70. The potential gas leak distribution 560 is shown starting from sensor 510 where the increased gas level was detected (as shown in FIG. 5A). The web application can show a picture of the potential gas distribution at a specific future time. In the alternative, the web application can show a video of the gas plume dispersing from the point of origin throughout the facility. Workers within the facility can access the web application at all times in order to determine whether an increased gas level has been detected within the facility. Additionally, the web application can show the location of the mobile device.

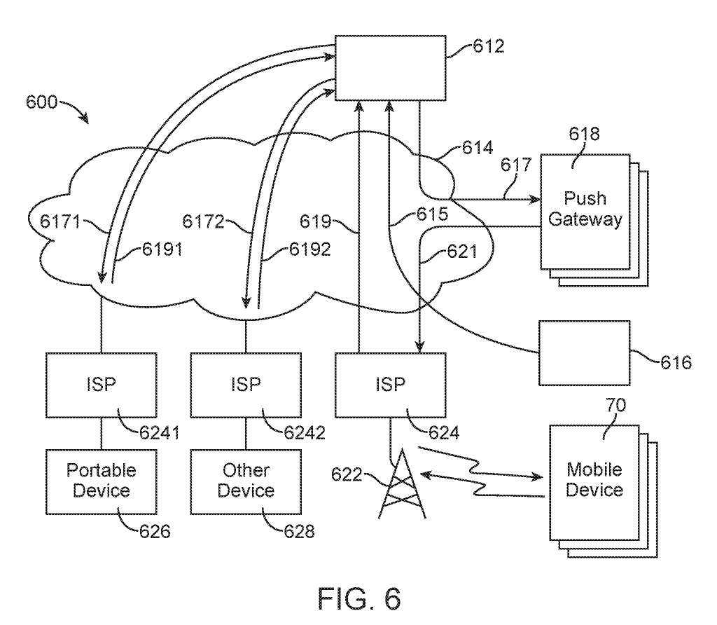

In an alternative method, a push notification can be used to immediately alert workers of a gas leak. FIG. 6 illustrates an exemplary system 600 for sending push notifications. A notification server system 612, comprising one or more servers, can be communicatively coupled with a network 614 for Transmission Control Protocol/Internet Protocol (TCP/IP). A memory in the notification server system 612 can store program instructions including a number of code segments for implementing various processes of the notification server system 612. For example, the notification server system 612 can include code segments for receiving a received push notification 615 from a push originator server system 616 (such as a web application) via the network 614. The received push notification 615 can include a message and a destination.

The notification server system 612 can also include code segments for creating a send token and sent push notification 615, for example, a sent push notification 617, derived from the received push notification 615. The send token can be used to distinguish the sent push notification 617 from other push notifications. For example, the sent push notification 617 with send token can be sent over the network 614 to a push gateway server system 618. The push gateway server system 618 can then send a push notification 621 to a mobile device 70. In the alternative, a sent push notification 6171/6172 with send token can be sent to other destinations, such as a proxy server or other device.

In the illustrated example, gateway server system is 618 is typically provided by a provider implementing push notification protocols which are particular to, for example, a certain type of mobile device 70.

Code segments are also included in notification server system 612 for receiving received push information 619/6191/6192 concerning a processing of the sent push notification 617. These code segments can, for example, identify the sent push notification from the received push information 619 by the send token. For example, received push information can be developed by a mobile device 70 which is coupled to a cellular network 622 and from there to the network 614, such as by an Internet Service Provider (ISP) 624. TCP/IP protocol communications can thus occur between mobile device 70 and notification server system 612 including the received push information 619.

It should be known by those in the art that a mobile device 70 is only one example of a device that can receive push notifications. In the alternative, a portable device 626 can communicate through a network 614 via an ISP 6241 using a Wireless Fidelity (WiFi) or cable connection. Other devices 628, such as personal computers, can also communicate with a network 614 via an ISP 6242. It should be obvious to those in the art that mobile devices 70, portable devices 626, and other devices 628 can receive sent push notifications 617 without the intermediary of a push gateway server 618. The push notifications can be customized based on the GPS location of the worker's mobile device such that the notification can inform each worker's risk level.

Numerous examples are provided herein to enhance understanding of the present disclosure. A specific set of statements are provided as follows.

Statement 1: A gas leak detection system comprising a plurality of sensors spaced throughout a facility capable of acquiring real-time data; a server communicatively coupled with each of the plurality of sensors, a processor, and a memory, the memory storing instructions which, when executed, cause the processor to receive and accumulate the real-time data acquired by each of the plurality of sensors, scrub the accumulated data to remove a plurality of spikes, a plurality of white noise, or a combination thereof, from the real-time data to yield a set of scrubbed data, determine, based on the scrubbed data, a gas leak location within the facility, conduct a gas leak simulation based on the scrubbed data and determine a potential gas leak distribution, access a database communicatively coupled with the processor, the database storing a set of predetermined risk parameters and a facility geometry, calculate a risk profile based on the set of predetermined risk parameters, and transmit the risk profile and the potential gas leak distribution to the server; a web service communicatively coupled with the server; a web application communicatively coupled to a network, the web application embodied in the web service comprising instructions for receiving the potential gas leak distribution and the risk profile, generating a notification based on the potential gas leak distribution and the risk profile, and transmitting the notification over the network; and at least one mobile device communicatively coupled to the network and receiving the notification from the web application.

Statement 2: A system according to Statement 1, wherein each of the plurality of sensors are one of a wind velocity sensor, a wind direction sensor, a gas sensor, or a combination thereof.

Statement 3: A system according to Statement 1 or Statement 2, wherein the real-time data is one of a leak point, a leak rate, a gas component, a gas concentration, or a combination thereof.

Statement 4: A system according to Statements 1-3, wherein the gas component is one of a hydrogen sulfide gas, a carbon dioxide gas, a methane gas, or a combination thereof.

Statement 5: A system according to Statements 1-4, wherein the gas leak simulation further comprises applying a Realizable k-E model.

Statement 6: A system according to Statements 1-5, further comprising repeating the gas leak simulation as additional real-time data is obtained.

Statement 7: A system according to Statements 1-6, wherein the notification is transmitted to the at least one mobile device over the network when a gas leak is detected.

Statement 8: A system according to Statements 1-7, wherein the notification is transmitted from the web application via push notification.

Statement 9: A system according to Statements 1-8, wherein the notification is transmitted from the web application to the at least one mobile device over a cellular network.

Statement 10: A method comprising receiving, via a server, real-time data measured via a plurality of sensors spaced throughout a facility; scrubbing, via the server, the real-time data by removing a plurality of spikes, a plurality white noise, or a combination thereof, from the real-time data to yield a set of scrubbed data; determining, via the server, a gas leak location within the facility based on the scrubbed data; conducting, via the server, a gas leak simulation based on the scrubbed data; determining a potential gas leak distribution based on the scrubbed data and the gas leak simulation; calculating, by the server, a risk profile based on a set of predetermined risk parameters and a facility geometry; and transmitting, via the server over a network, the risk profile and the potential gas leak distribution to a second server.

Statement 11: A method according to Statement 10, further comprising generating a notification based on the potential gas leak distribution and the risk profile; and transmitting the notification over the network to at least one mobile device.

Statement 12: A method according to Statement 10 or Statement 11, wherein each of the plurality of sensors are one of a wind velocity sensor, a wind direction sensor, a gas sensor, or a combination thereof.

Statement 13: A method according to Statements 10-12, wherein the real-time data is one of a leak point, a leak rate, a gas component, a gas concentration, or a combination thereof.

Statement 14: A method according to Statements 10-13, wherein the gas component is one of a hydrogen sulfide gas, a carbon dioxide gas, a methane gas, or a combination thereof.

Statement 15: A method according to Statements 10-14, wherein conducting the gas leak simulation further comprises applying a Realizable k-E model.

Statement 16: A method according to Statements 10-15, further comprising repeating the gas leak simulation as additional real-time data is obtained.

Statement 17: A method according to Statements 10-16, further comprising sending the notification to the at least one mobile device via push notification.

Statement 18: A method according to Statements 10-17, further comprising sending the notification to the at least one mobile device over a cellular network.

Statement 19: A computer-readable storage device having stored therein instructions which, when executed by the processor, cause the processor to perform operations comprising receiving real-time data measured via a plurality of sensors spaced throughout a facility; scrubbing the real-time data by removing a plurality of spikes, a plurality of white noise, or a combination thereof, from the real-time data to yield a set of scrubbed data; determining a gas leak location within the facility based on the scrubbed data; conducting a gas leak simulation based on the scrubbed data; determining a potential gas leak distribution based on the scrubbed data and the gas leak simulation; calculating a risk profile based on a set of predetermined risk parameters and a facility geometry; and transmitting, over a network, the risk profile and the potential gas leak distribution to a server

Statement 20: A computer-readable storage device according to Statement 19, wherein each of the plurality of sensors are one of a wind velocity sensor, a wind direction sensor, a gas sensor, or a combination thereof.

Statement 21: A computer-readable storage device according to Statement 19 or Statement 20, wherein the real-time data is one of a leak point, a leak rate, a gas component, a gas concentration, or a combination thereof.

Statement 22: A computer-readable storage device according to Statements 19-21, wherein the gas component is one of a hydrogen sulfide gas, a carbon dioxide gas, a methane gas, or a combination thereof.

Statement 23: A computer-readable storage device according to Statements 19-22, wherein conducting the gas leak simulation further comprises applying a Realizable k-E model.

Statement 24: A computer-readable storage device according to Statements 19-23, further comprising repeating the gas leak simulation as additional real-time data is obtained.

Statement 25: A computer-readable storage device according to Statements 19-24, wherein a notification is transmitted to the at least one mobile device over the network when a gas leak is detected.

Statement 26: A computer-readable storage device according to Statements 19-25, wherein the notification is sent to the at least one mobile device via push notification.

Statement 27: A computer-readable storage device according to Statements 19-26, wherein the notification is sent to the at least one mobile device over a cellular network.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A gas leak detection system comprising:
a plurality of sensors spaced throughout a facility capable of acquiring real-time data;
a server communicatively coupled with each of the plurality of sensors, a processor, and a memory, the memory storing instructions which, when executed, cause the processor to:
receive and accumulate the real-time data acquired by each of the plurality of sensors,
scrub the accumulated data to remove a plurality of spikes, a plurality of white noise, or a combination thereof, from the real-time data to yield a set of scrubbed data,
determine, based on the scrubbed data, a gas leak location within the facility,
conduct a gas leak simulation based on the scrubbed data and determine a potential gas leak distribution,
access a database communicatively coupled with the processor, the database storing a set of predetermined risk parameters and a facility geometry,
calculate a risk profile based on the set of predetermined risk parameters, and
transmit the risk profile and the potential gas leak distribution to the server;
a web service communicatively coupled with the server;
a web application communicatively coupled to a network, the web application embodied in the web service comprising instructions for:
receiving the potential gas leak distribution and the risk profile,
generating a notification based on the potential gas leak distribution and the risk profile, and
transmitting the notification over the network; and
at least one mobile device communicatively coupled to the network and receiving the notification from the web application.

2. The system as claimed in claim 1, wherein each of the plurality of sensors are one of a wind velocity sensor, a wind direction sensor, a gas sensor, or a combination thereof.

3. The system as claimed in claim 1, wherein the real-time data is one of a leak point, a leak rate, a gas component, a gas concentration, or a combination thereof.

4. The system as claimed in claim 3, wherein the gas component is one of a hydrogen sulfide gas, a carbon dioxide gas, a methane gas, or a combination thereof.

5. The system as claimed in claim 1, wherein the gas leak simulation further comprises applying a Realizable k-E model.

6. The system as claimed in claim 1, further comprising repeating the gas leak simulation as additional real-time data is obtained.

7. The system as claimed in claim 1, wherein the notification is transmitted to the at least one mobile device over the network when a gas leak is detected.

8. A method comprising:
receiving, via a server, real-time data measured via a plurality of sensors spaced throughout a facility;
scrubbing, via the server, the real-time data by removing a plurality of spikes, a plurality white noise, or a combination thereof, from the real-time data to yield a set of scrubbed data;
determining, via the server, a gas leak location within the facility based on the scrubbed data;
conducting, via the server, a gas leak simulation based on the scrubbed data;
determining a potential gas leak distribution based on the scrubbed data and the gas leak simulation;
calculating, by the server, a risk profile based on a set of predetermined risk parameters and a facility geometry; and
transmitting, via the server over a network, the risk profile and the potential gas leak distribution to a second server.

9. The method of claim 8, further comprising:
generating a notification based on the potential gas leak distribution and the risk profile; and
transmitting the notification over the network to at least one mobile device.

10. The method of claim 8, wherein each of the plurality of sensors are one of a wind velocity sensor, a wind direction sensor, a gas sensor, or a combination thereof.

11. The method of claim 8, wherein the real-time data is one of a leak point, a leak rate, a gas component, a gas concentration, or a combination thereof.

12. The method of claim 11, wherein the gas component is one of a hydrogen sulfide gas, a carbon dioxide gas, a methane gas, or a combination thereof.

13. The method of claim 8, wherein conducting the gas leak simulation further comprises applying a Realizable k-E model.

14. The method of claim 8, further comprising repeating the gas leak simulation as additional real-time data is obtained.

15. A computer-readable storage device having stored therein instructions which, when executed by the processor, cause the processor to perform operations comprising:
receiving real-time data measured via a plurality of sensors spaced throughout a facility;
scrubbing the real-time data by removing a plurality of spikes, a plurality of white noise, or a combination thereof, from the real-time data to yield a set of scrubbed data;
determining a gas leak location within the facility based on the scrubbed data;
conducting a gas leak simulation based on the scrubbed data;
determining a potential gas leak distribution based on the scrubbed data and the gas leak simulation;
calculating a risk profile based on a set of predetermined risk parameters and a facility geometry; and
transmitting, over a network, the risk profile and the potential gas leak distribution to a server.

16. The computer-readable storage device of claim 15, wherein each of the plurality of sensors are one of a wind velocity sensor, a wind direction sensor, a gas sensor, or a combination thereof.

17. The computer-readable storage device of claim 15, wherein the real-time data is one of a leak point, a leak rate, a gas component, a gas concentration, or a combination thereof.

18. The computer-readable storage device of claim 17, wherein the gas component is one of a hydrogen sulfide gas, a carbon dioxide gas, a methane gas, or a combination thereof.

19. The computer-readable storage device of claim 15, wherein conducting the gas leak simulation further comprises applying a Realizable k-E model.

20. The computer-readable storage device of claim 15, further comprising repeating the gas leak simulation as additional real-time data is obtained.
